(19) United States
(12) Patent Application Publication
(10) Pub. No.: US 2025/0051112 A1
(43) Pub. Date: Feb. 13, 2025

(54) CONVEYANCE APPARATUS

(71) Applicant: Adar SHECHTER, Kibbutz Shluhot (IL)

(72) Inventor: Adar SHECHTER, Kibbutz Shluhot (IL)

(21) Appl. No.: 18/719,452

(22) PCT Filed: Dec. 8, 2022
(86) PCT No.: PCT/IB2022/061933

§ 371 Date: Jun. 13, 2024

Related U.S. Application Data
(60) Provisional application No. 63/289,679, filed on Dec. 15, 2021.

(51) Int. Cl. B65G 67/02; B60P 1/64

(52) U.S. Cl. CPC B65G 67/02; B60P 1/64

(57) ABSTRACT

According to a first aspect of the present disclosed subject matter, a conveyance apparatus adapted to be transported by a flatbed truck, the conveyance apparatus comprising: a chassis having a bottom and engagement mechanisms; a plurality of telescopic legs operatively coupled to the bottom of the chassis for elevating and lowering the conveyance apparatus, and wherein the engagement mechanisms are configured to engage with the flatbed truck for securing the conveyance apparatus to the flatbed truck.

### CROSS-REFERENCE TO RELATED APPLICATION

This application claims priority under 35 U.S.C. § 119 (e) from U.S. Provisional Patent Application No. 63/289,679 titled “METHOD, SYSTEM, AND PRODUCT—PORTABLE STRUCTURE”, filed on Dec. 15, 2021, which is incorporated in its entirety by reference herein.

### TECHNICAL FIELD

The present disclosed subject matter relates to transportation. More particularly, the present disclosed subject matter relates to heavy-duty accessories for road transportation.

### BACKGROUND

Hauling uniquely shaped cargo that does not fit within the dimensions of standard trailers or heavy freight requires transportation by flatbed truck, flatbed trailer, or flatbed semitrailer. Such freight (cargo) cannot be loaded or unloaded from a dock and thus requires cranes, forklifts, or both.

Flatbed shipment provides dimensional flexibility for large freight due to the absence of side walls. Also, flatbed trucks can be loaded from either side and from the top and back. The length of the flatbed trailer can reach 48′ long by 8.5′ wide, with varying deck lengths for step decks. The process of loading flatbed shipments depends upon the particulars of the shipping location and the type of cargo being handled.

Appropriate equipment such as cranes, forklifts, or the like is needed for loading heavy and exceptionally shaped cargo. Usually, such equipment is available at the origin. However, the unloading and reloading process of the cargo at the destination can become a logistical and financial ordeal, especially when the destination is remote.

### BRIEF SUMMARY

According to a first aspect of the present disclosed subject matter, a conveyance apparatus adapted to be transported by a flatbed truck, the conveyance apparatus comprising: a chassis having a bottom and engagement mechanisms; a plurality of telescopic legs operatively coupled to the bottom of the chassis for elevating and lowering the conveyance apparatus, and wherein the engagement mechanisms are configured to engage with the flatbed truck for securing the conveyance apparatus to the flatbed truck.

In some exemplary embodiments, the chassis is made of a combination of trusses and rafters covered by sheet metal, and wherein the chassis comprises a plurality of hooks disposed along sides of the chassis for harnessing a load carried by the conveyance apparatus to the conveyance apparatus.

In some exemplary embodiments, the chassis has a shape having at least two opposite sides that can be used as loading ends for loading the conveyance apparatus on the flatbed truck, and wherein each the loading end comprises a pair of the telescopic legs spaced apart by a distance greater than the flatbed truck width.

In some exemplary embodiments, the engagement mechanisms are comprised of a plurality of twist lock sockets configured to engage with matching twist lock pins of the flatbed truck.

In some exemplary embodiments, the conveyance apparatus further comprises a generator utilized for powering the plurality of telescopic legs, and wherein the generator is selected from the group consisting of an electrical generator; a hydraulic generator; a pneumatic generator; and combinations thereof.

In some exemplary embodiments, the generator comprises a controller having a Global Positioning System (GPS) sensor and a wireless transceiver, and wherein the controller uses the GPS sensor to determine information indicating the location of the conveyance apparatus, and transmit the information to a remote computerized device and receive instructions for separately activate each telescopic leg of the plurality of telescopic legs.

In some exemplary embodiments, each telescopic leg of the plurality of telescopic legs comprises a linear actuator configured to lengthen and shorten the telescopic leg for elevating and lowering the conveyance apparatus respectively, and wherein the linear actuator is powered and controlled by the generator.

In some exemplary embodiments, each telescopic leg of the plurality of telescopic legs further comprises a rotational actuator; a shaft; and a wheel, wherein the rotational actuator is configured to swivel and roll the wheel by the shaft in order to maneuver the conveyance apparatus to a required location, and wherein the rotational actuator is powered and controlled by the generator.

In some exemplary embodiments, the load is integrated with the conveyance apparatus, thereby forming a portable structure.

In some exemplary embodiments, the portable structure is selected from the group consisting of a house; an office; a storage; a laboratory; a military command and control; a medical first aid station; and combinations thereof.

In some exemplary embodiments, the generator is an external auxiliary generator.

According to a another aspect of the present disclosed subject matter, a method of loading the conveyance apparatus of claim 10 onto the flatbed truck, the method comprising: elevating the conveyance apparatus by lengthening the telescopic legs; driving the flatbed truck under the chassis; moving the conveyance apparatus so that the engagement mechanisms align with the matching engagement mechanisms of the flatbed truck; lowering the conveyance apparatus by shortening the telescopic legs so that the chassis rests over on the flatbed truck; and engaging the engagement mechanisms with the matching engagement mechanisms.

In some exemplary embodiments, the moving comprises swiveling and rolling the wheels.

In some exemplary embodiments, the elevating, lowering, swiveling, and rolling are controlled by a remote computerized device comprising a dedicated software application, and wherein the computerized device is selected from the group consisting of a laptop computer; a tablet; a desktop computer; a smartphone; and any combination thereof.

According to yet another aspect of the present disclosed subject matter, a method of unloading the conveyance apparatus of claim 10, off the flatbed truck onto a surface of a venue, the method comprising: disengaging the engagement mechanisms from the matching engagement mechanisms of the flatbed truck; lengthening the telescopic legs against the surface in order to elevate the conveyance apparatus above the flatbed truck; driving the flatbed truck away from the conveyance apparatus; and moving the conveyance apparatus on the surface to a location in the venue by swiveling and rolling the wheels.

In some exemplary embodiments, the moving comprises swiveling and rolling the wheels, thereby moving the conveyance apparatus or the portable structure on the surface to a desired location in the venue.

In some exemplary embodiments, the lengthening, swiveling, and rolling are controlled by a remote computerized device comprising a dedicated software application, and wherein the computerized device is selected from the group consisting of a laptop computer; a tablet; a desktop computer; a smartphone; and any combination thereof.

In some exemplary embodiments, the at least two portable structures are mechanically connected to one another.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1 illustrates an isometric view of a conveyance apparatus and a load, in accordance with some exemplary embodiments of the disclosed subject matter;

FIG. 2 illustrates an isometric view of a portable-structure, in accordance with some exemplary embodiments of the disclosed subject matter;

FIG. 3 shows a cross-section view of a telescopic leg, in accordance with some exemplary embodiments of the disclosed subject matter;

FIG. 4A illustrates a side view of a flatbed truck and the conveyance apparatus with cargo, in pre/post loading position, in accordance with some exemplary embodiments of the disclosed subject matter;

FIG. 4B illustrates a back view of the flatbed truck and the conveyance apparatus, with cargo, in pre/post loading position, in accordance with some exemplary embodiments of the disclosed subject matter;

FIG. 4C illustrates a side view of the conveyance apparatus, having cargo, loaded on the flatbed truck, in accordance with some exemplary embodiments of the disclosed subject matter;

FIG. 4D illustrates a back view of the conveyance apparatus, having cargo, loaded on the flatbed truck, in accordance with some exemplary embodiments of the disclosed subject matter; and

FIG. 5 illustrates a layout of a plurality of conveyance apparatuses deployed in a venue, in accordance with some exemplary embodiments of the disclosed subject matter.

### DETAILED DESCRIPTION

One objective of the present disclosed subject matter is to provide a conveyance apparatus adapted to be transported by a flatbed truck. In some exemplary embodiments, the conveyance apparatus eliminates the need for hoisting equipment for loading and unloading cargo on and off the flatbed truck.

Another objective of the present disclosure is to provide a portable structure, such as a house, an office, storage, a laboratory, or the like. In some exemplary embodiments, the portable structure may be an integral part of the conveyance apparatus. Thereby, eliminating the need for hoisting equipment required for loading, unloading, and positioning the portable structure in a remote venue.

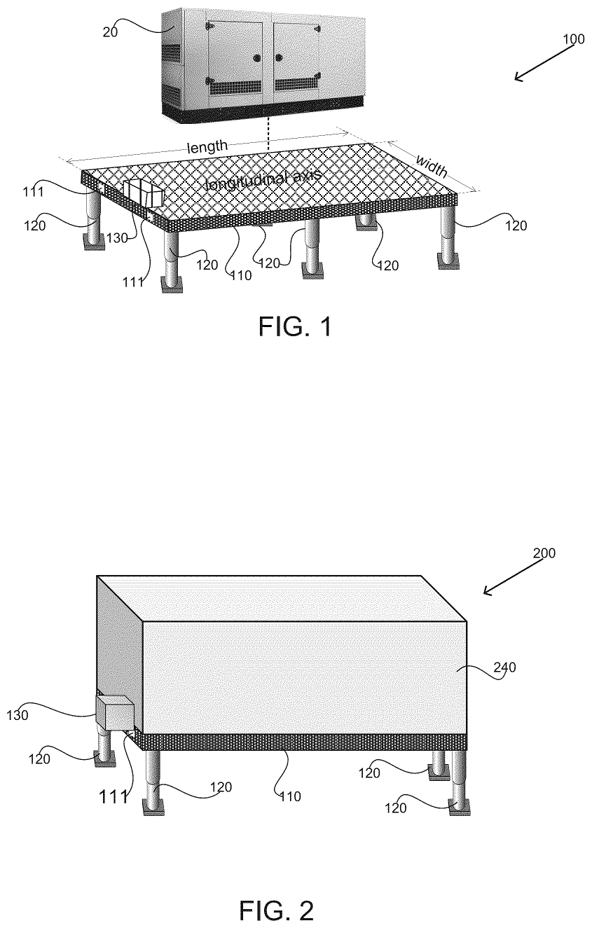

Referring now to FIG. 1 illustrating an isometric view of a conveyance apparatus and a load, in accordance with some exemplary embodiments of the disclosed subject matter.

A Conveyance Apparatus 100 may be a transportation accessory configured to carry and secure (harness) heavy and wide (out-of-gauge) cargo, such as Load 20. In some exemplary embodiments, Conveyance-Apparatus 100 may be utilized for deployment with loads/cargo it carries in a variety of venues. In some exemplary embodiments, Conveyance-Apparatus 100 is designed to be loaded, unloaded, and secured on top of a flatbed truck, a flatbed trailer, a flatbed semi-trailer, and the like for transportation. Load 20 may be, for example, a generator, a large transformer, a house, an office, a large satellite dish, a laboratory, and the like, or any combination thereof.

It should be noted that the terms cargo and load are referred to interchangeably herein, meaning at least one payload carried by Conveyance-Apparatus 100. Additionally, the term “flatbed truck” used throughout this disclosure refers also to a flatbed trailer and a flatbed semi-trailer.

In some exemplary embodiments of the disclosed subject matter, Conveyance-Apparatus 100 may be comprised of a Chassis 110, at least four (4) Telescopic-Legs 120, a Generator 130, and at least four (4) engagement mechanisms 111.

In some exemplary embodiments, Chassis 110 can be made of rigid material, such as of steel, polymers material, or a combination of materials having similar or better strength. Chassis 100 structure may be comprised of a combination of trusses and rafters forming together a structure (Chassis 100) having strength for carrying the maximum gross load allowed to be carried by the flatbed truck. In some exemplary embodiments, the upper face of Chassis 110 may be covered by sheet metal (skin). Additionally, or alternatively, Chassis 110 may be provided with a plurality of hooks and rings (not shown) that are disposed along the sides of Chassis 110 and are used for harnessing (chaining) loads, such as Load 20 to Chassis 110. It will be appreciated that Chassis 110 can be provided in a variety of sizes, i.e., different lengths and widths. It will also be appreciated that the longitudinal axis of Chassis 110, and therefore the longitudinal axis of Conveyance-Apparatus 100, overlaps a longitudinal axis of a standard flatbed truck.

It will be noted that Chassis 110 may be a symmetrical platform namely, opposite sides mirror each other. In some exemplary embodiments, two opposite sides, out of the four sides, can be used as loading ends, i.e., sides from which Conveyance-Apparatus 100 can be loaded on a flatbed truck. However, in some particular embodiments, all four sides can be used as loading ends.

Engagement mechanisms 111 are utilized for securing (anchoring) Conveyance-Apparatus 100 to a flatbed truck for transportation. In some exemplary embodiments, engagement mechanisms 111 may be commercially available Twist lock sockets that are configured to engage with commercially available twist lock pins of a flatbed truck for the purpose of securing Conveyance-Apparatus 100 to a flatbed truck, similar to the way that shipping containers are anchored to flatbed trucks. Chassis 110 may comprise at least one pair of twist lock sockets at each loading end. In some exemplary embodiments, Chassis 110 may comprise additional pairs of Twist-Lock-Socket disposed along its length. It should be noted that the distance between a pair of twist lock sockets and between pairs of Twist lock sockets comply with standard distances between a pair of twist-lock pins and between twist-lock pins pairs, of any standard flatbed truck.

Additionally, or alternatively, engagement mechanisms 111 may be comprised of a plurality of chains, binders and straps adapted for anchoring Conveyance-Apparatus 100 to hooks and rings of the flatbed.

In some exemplary embodiments, at least one Telescopic-Leg 120 may be connected to the bottom of each corner of Chassis 110 so that Telescopic-Legs 120 protrudes towards the ground. Optionally, additional Telescopic-Legs 120 may be connected near the longitudinal sides of Chassis 110. In some exemplary embodiments, Each Telescopic-Leg 120 can be configured to change its length, i.e., longer or shorter, separately, either manually or by a force generator. In some exemplary embodiments, Telescopic-Legs 120 may be lengthened for loading/unloading Conveyance-Apparatus 100 on a flatbed truck. Alternatively, Telescopic-Legs 120 may be shortened for deploying Conveyance-Apparatus 100 on a surface, e.g., ground, of a venue, and when harnessing Conveyance-Apparatus 100 on top of a flatbed truck before transportation.

It will be noted that two opposite sides of Conveyance-Apparatus 100 may be configured as loading ends. In some exemplary embodiments, a loading end can't comprise more than two Telescopic-Leg 120 to allow driving the flatbed under Chassis 110 and in between Telescopic-Leg 120. Additionally, or alternatively, the space between the two Telescopic-Leg 120 on each loading end has to be larger than a width of a standard flatbed.

In some exemplary embodiments, Generator 130 may be an electrical generator, a hydraulic generator, a pneumatic generator, and the like, or any combination thereof. Generator 130 may be utilized for supplying energy to linear and rotational actuators (to be described in detail further below) of each Telescopic-Leg 120 for the purpose of elevating/lowering and moving Conveyance-Apparatus 100. In some exemplary embodiments, Generator 130 may be powered by a commercially available diesel or other fossil fuel generator. Additionally, or alternatively, Generator 130 may be powered by chargeable batteries.

In some exemplary embodiments, Generator 130 may be an external auxiliary generator, which may be connected to Conveyance-Apparatus 100 as needed.

Generator 130 may be configured to individually (separately) control each Telescopic-Leg 120 and its subcomponents. It should be noted that the terms lengthened/shortened are referred to interchangeably herein as elevating/lowering

In some exemplary embodiments, Generator 130 may comprise a controller (not shown) that retains program code operative to cause acts associated with determining Conveyance-Apparatus 100 location, propelling it, and communicating with external devices. In some exemplary embodiments, the controller comprises a Global Positioning System (GPS) sensor configured to determine information indicating the location of the Conveyance-Apparatus 100. Additionally, or alternatively, the controller is adapted to control all functionalities, i.e., propelling, of all the telescopic legs (to be described in detail further below) of Conveyance-Apparatus 100. Thereby, controlling the elevation and the movement of Conveyance-Apparatus 100 in a venue. Additionally, or alternatively, the controller is configured to wirelessly communicate with a remote computerized device (not shown), such as a laptop computer, a tablet, a desktop computer, a smartphone, and the like, or any combination thereof.

The computerized device (not shown) may employ a dedicated software application utilized as a control interface that transmits and receives, by a wireless transceiver, information, and instructions to and from the computerized device. In some exemplary embodiments, an operator, of Conveyance-Apparatus 100, may use the computerized device (not shown) for providing instructions for separately activating each Telescopic-Leg 120 of the plurality of the Telescopic-Legs 120. Thereby, elevating, lowering, and moving, i.e., maneuvering, Conveyance-Apparatus 100 in a venue based on GPS information that indicates the location of the Conveyance-Apparatus 100. Additionally, or alternatively, the computerized device may be configured to output visualized results, reports, or the like. It will be appreciated that the computerized device (not shown) may be used as a control interface for a plurality of Conveyance-Apparatus 100 simultaneously.

In some exemplary embodiments, Generator 130 comprises a controller, which incorporates a GPS sensor and a wireless transceiver. The controller may use the GPS sensor to determine information indicating the location of Conveyance-Apparatus 100 and transmit, with the wireless transceiver, that information to the remote computerized device. Additionally, or alternatively, the controller may use the wireless transceiver to receive, from the remote computerized device, instructions for separately activating each telescopic leg of said plurality of telescopic legs.

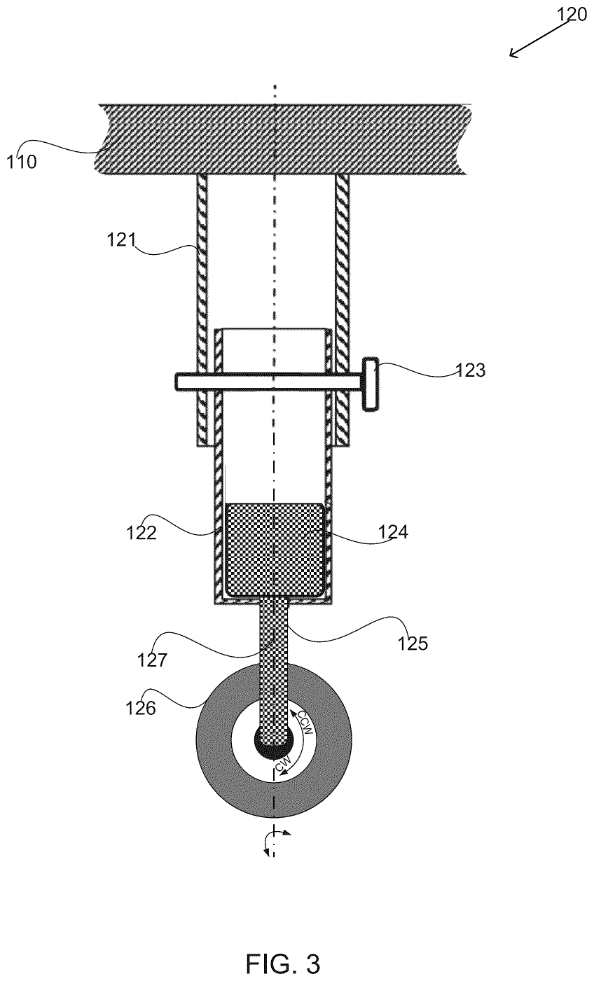

Referring now to FIG. 2 illustrating an isometric view of a portable-structure, in accordance with some exemplary embodiments of the disclosed subject matter.

A Portable-Structure 200 may be comprised of Conveyance-Apparatus 100, of FIG. 1, and a structure integrated with it. In some exemplary embodiments, Portable-Structure 200 may be a house, an office, a storage, a laboratory, a military command & control, a laboratory, a medical first aid station, and the like, or any combination thereof. The purpose of providing Portable-Structure 200 of the present disclosure is to address the need for fast and low-cost deployment of ready-to-use facilities comprised in Portable-Structure 200.

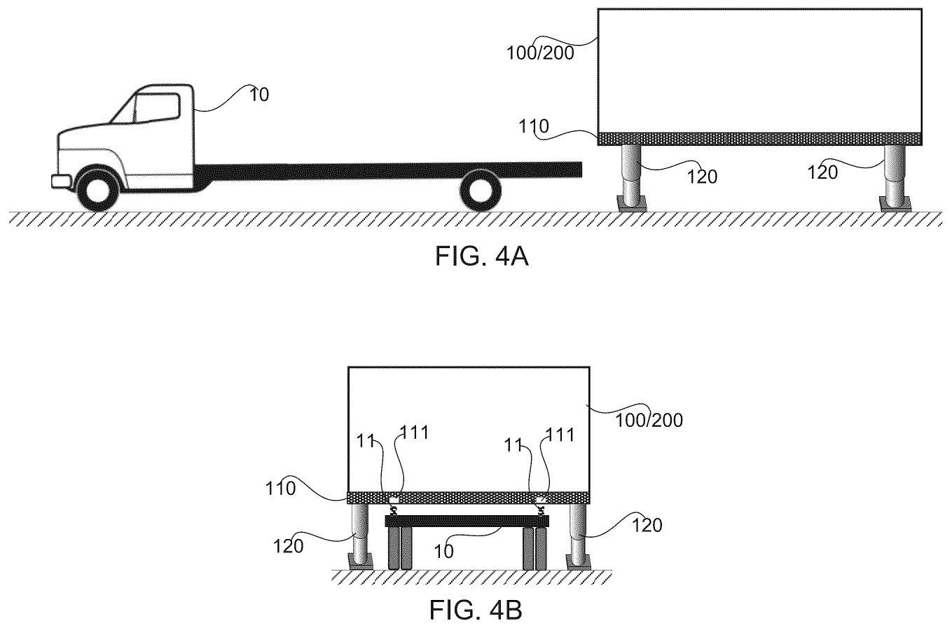

Referring now to FIG. 3 showing a cross-section view of a telescopic leg, in accordance with some exemplary embodiments of the disclosed subject matter.

Telescopic-Leg 120 may be comprised of a Piston 122, a Linear-Actuator 123, a Rotational-Actuator 124, a Shaft 125, a Wheel 126, and a Cylinder 121. In some exemplary embodiments, Cylinder 121 is operatively coupled to the bottom of Chassis 110, by means, such as welding, bolts, commercially available connectors and the like, or any combination thereof.

In some exemplary embodiments, Linear-Actuator 123 may be configured to slide Piston 122 up and down within Cylinder 121 so that the whole Telescopic-Leg 120 can be made longer or shorter. Both Cylinder 121 and Piston 122 may have a similar geometrical cross-sectional shape, which allows accommodating Piston 122 inside Cylinder 121 so that Piston 122 can slide inside Cylinder 121 upon activating of Linear-Actuator 123. In some exemplary embodiments, Linear-Actuator 123 may be a hydraulic actuator, an electrical actuator, a pneumatic actuator, and the like, or any combination thereof, which may be controlled and energized by Generator 130, of FIGS. 1 and 2.

In some exemplary embodiments, Rotational-Actuator 124 may be configured to swivel Wheel 126 around an Axis 127. Additionally, or alternatively, Rotational-Actuator 124 may be also configured to roll Wheel 126 clockwise (CW), and counterclockwise (CCW). In some exemplary embodiments, Rotational-Actuator 124 may be a hydraulic actuator, an electrical actuator, a pneumatic actuator, and the like, or any combination thereof that can be controlled and energized by Generator 130, of FIGS. 1 and 2. Additionally, or alternatively, Wheel 126 can be locked in position to prevent the movement of Conveyance-Apparatus 100. This is typically done after deploying Conveyance-Apparatus 100 in the desired location.

It will be appreciated that by swiveling and rolling Wheel 126, Conveyance-Apparatus 100 can be maneuvered to a location required for either deploying Conveyance-Apparatus 100 in the desired location or loading it on a flatbed truck. It will be appreciated that maneuvering Conveyance-Apparatus 100 allows driving the Conveyance-Apparatus 100 forward, backward, and sideways, as well as rotating it around its axis.

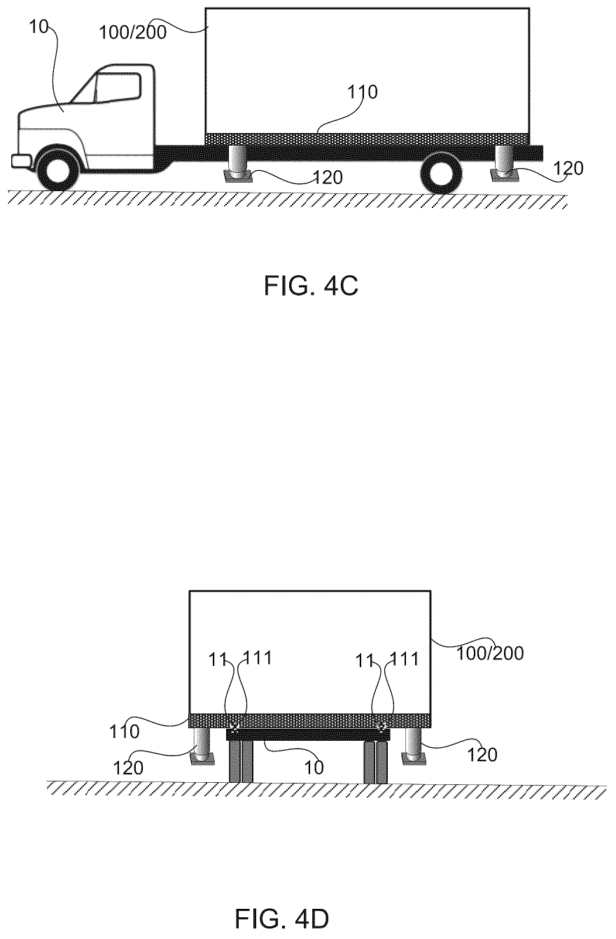

Referring now to FIGS. 4A and 4B, illustrating side and back views of a flatbed truck and the conveyance apparatus with cargo, in pre/post loading position, and FIGS. 4C and 4D, illustrating side and back views of the conveyance apparatus, having cargo, loaded on the flatbed truck, in accordance with some exemplary embodiments of the disclosed subject matter

In some exemplary embodiments, a Conveyance-Apparatus 100 may be loaded on a Flatbed-Truck 10. The loading may be a process that comprises the following steps:

Lengthening Telescopic-Legs 120 for elevating Conveyance-Apparatus 100 to a height that allows Flatbed-Truck 10 to clear under Chassis 110 and then driving Flatbed-Truck 10 under Chassis 110.

Moving Conveyance-Apparatus 100 into a position where engagement mechanisms 111, for example twist lock sockets, of Chassis 110 are aligned directly above matching engagement mechanisms 11, for example twist lock pins, of the flatbed truck.

Followed by lowering Conveyance-Apparatus 100 by shortening Telescopic-Legs 120 so that Chassis 110 rests over on the flatbed, and all matching engagement mechanisms 11 overlap engagement mechanisms 111.

In some exemplary embodiments, the loading may be concluded by engaging and locking all twist lock pins with associated twist lock socket, i.e., engaging and locking engagement mechanisms 111 with matching engagement mechanisms 11.

In some exemplary embodiments, a process of unloading a Conveyance-Apparatus 100 off a Flatbed-Truck 10, may be comprised of the following steps:

Disengaging all engagement mechanisms 111 from matching engagement mechanisms 11 of Flatbed-Truck 10.

Lengthening Telescopic-Legs 120 against the ground for elevating Conveyance-Apparatus 100 above Flatbed-Truck 10 height.

Driving Flatbed-Truck 10 away from Chassis 110.

Moving Conveyance-Apparatus 100 on the ground (surface) to a location by swiveling and rolling Wheel 126, with Rotational-Actuators 124 of Telescopic-Leg 120.

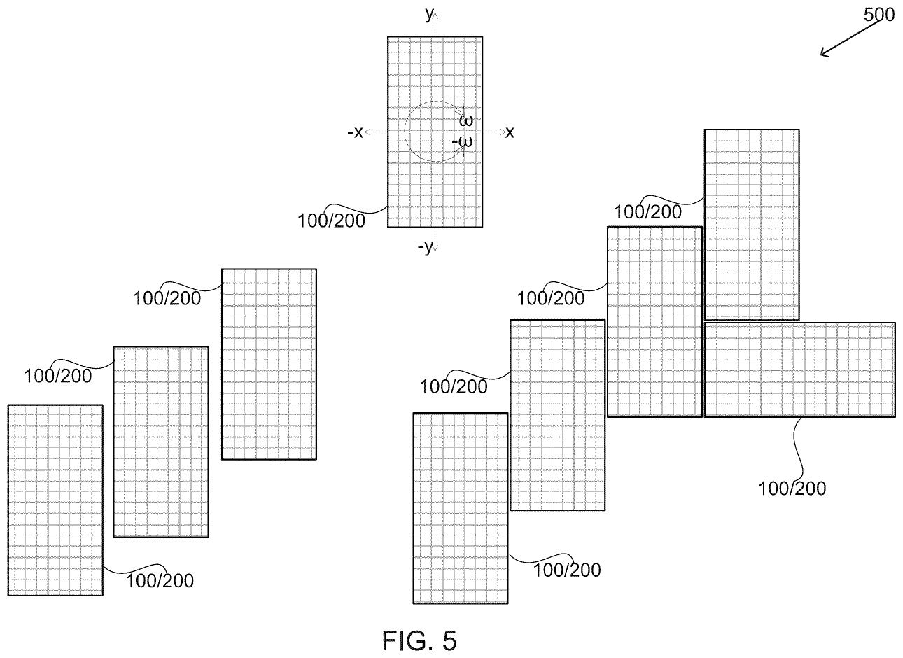

Referring now to FIG. 5 illustrating a layout of a plurality of Conveyance-Apparatus 100 and or Portable-Structure 200 deployed in a venue, in accordance with some exemplary embodiments of the disclosed subject matter.

In some exemplary embodiments, a plurality of Conveyance-Apparatus 100 (of FIG. 1) and or Portable-Structure 200 (of FIG. 2) may be deployed in a Venue 500 for forming a colony, such as a military camp, a settlement, a resort, a work camp, an urban-like complex, and the like, or any combination thereof. Additionally, or alternatively, at least two Conveyance-Apparatus 100 (of FIG. 1) and or Portable-Structure 200 (of FIG. 2) may be mechanically connected to one another by commercially available means for creating a large structure and/or combined complex.

In some exemplary embodiments, the operator may utilize the computerized device used to remotely control Generator 130 of each Conveyance-Apparatus 100 (of FIG. 1) and or Portable-Structure 200 (of FIG. 2) for maneuvering them to any desired location in Venue 500 and setting its height.

It is to be understood that the disclosed subject matter is not limited in its application to the details of construction and the arrangement of the components set forth in the description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, some elements may have been omitted from some of the drawings.

The terms “comprises”, “comprising”, “includes”, “including”, and “having” together with their conjugates mean “including but not limited to”. The term “consisting of” has the same meaning as “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination or as suitable in any other described embodiment of the disclosed subject matter. Certain features described in the context of various embodiments are not to be considered essential features of those embodiments, unless the embodiment is inoperative without those elements.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosed subject matter.

What is claimed is:

1. A conveyance apparatus adapted to be transported by a flatbed truck, the conveyance apparatus comprising:
a chassis having a bottom and engagement mechanisms;
a plurality of telescopic legs operatively coupled to the bottom of said chassis for elevating and lowering said conveyance apparatus, and wherein said engagement mechanisms are configured to engage with the flatbed truck for securing said conveyance apparatus to the flatbed truck.

2. The conveyance apparatus of claim 1, wherein said chassis is made of a combination of trusses and rafters covered by sheet metal, and wherein said chassis comprises a plurality of hooks disposed along sides of said chassis for harnessing a load carried by said conveyance apparatus to said conveyance apparatus.

3. The conveyance apparatus of claim 1, wherein said chassis has a shape having at least two opposite sides that can be used as loading ends for loading said conveyance apparatus on the flatbed truck, and wherein each said loading end comprises a pair of said telescopic legs spaced apart by a distance greater than the flatbed truck width.

4. The conveyance apparatus of claim 1, wherein said engagement mechanisms are comprised of a plurality of twist lock sockets configured to engage with matching twist lock pins of the flatbed truck.

5. The conveyance apparatus of claim 1, further comprises a generator utilized for powering said plurality of telescopic legs, and wherein said generator is selected from the group consisting of an electrical generator; a hydraulic generator; a pneumatic generator; and combinations thereof.

6. The conveyance apparatus of claim 1, wherein said generator comprises a controller having a Global Positioning System (GPS) sensor and a wireless transceiver, and wherein the controller uses the GPS sensor to determine information indicating the location of said conveyance apparatus, and transmit the information to a remote computerized device and receive instructions for separately activate each telescopic leg of said plurality of telescopic legs.

7. The conveyance apparatus of claim 6, wherein each telescopic leg of said plurality of telescopic legs comprises a linear actuator configured to lengthen and shorten said telescopic leg for elevating and lowering said conveyance apparatus respectively, and wherein said linear actuator is powered and controlled by said generator.

8. The conveyance apparatus of claim 7, wherein each telescopic leg of said plurality of telescopic legs further comprises a rotational actuator; a shaft; and a wheel, wherein said rotational actuator is configured to swivel and roll said wheel by said shaft in order to maneuver said conveyance apparatus to a required location, and wherein said rotational actuator is powered and controlled by said generator.

9. The conveyance apparatus of claim 8, wherein the load is integrated with said conveyance apparatus, thereby forming a portable structure.

10. The conveyance apparatus of claim 9, wherein said portable structure is selected from the group consisting of a house; an office; a storage; a laboratory; a military command and control; a medical first aid station; and combinations thereof.

11. The conveyance apparatus of claim 5, wherein said generator is an external auxiliary generator.

12. A method of loading the conveyance apparatus of claim 10 onto the flatbed truck, the method comprising:
elevating the conveyance apparatus by lengthening the telescopic legs;
driving the flatbed truck under the chassis;
moving the conveyance apparatus so that the engagement mechanisms align with the matching engagement mechanisms of the flatbed truck;
lowering the conveyance apparatus by shortening the telescopic legs so that the chassis rests over on the flatbed truck; and
engaging the engagement mechanisms with the matching engagement mechanisms.

13. The method of claim 12, wherein said moving comprises swiveling and rolling the wheels.

14. The method of claim 13, wherein said elevating, lowering, swiveling, and rolling are controlled by a remote computerized device comprising a dedicated software application, and wherein the computerized device is selected from the group consisting of a laptop computer; a tablet; a desktop computer; a smartphone; and any combination thereof.

15. A method of unloading the conveyance apparatus of claim 10, off the flatbed truck onto a surface of a venue, the method comprising:
disengaging the engagement mechanisms from the matching engagement mechanisms of the flatbed truck;
lengthening the telescopic legs against the surface in order to elevate the conveyance apparatus above the flatbed truck;
driving the flatbed truck away from the conveyance apparatus; and
moving the conveyance apparatus on the surface to a location in the venue by swiveling and rolling the wheels.

16. The method of claim 15, wherein said moving comprises swiveling and rolling the wheels, thereby moving the conveyance apparatus or the portable structure on the surface to a desired location in the venue.

17. The method of claim 16, wherein said lengthening, swiveling, and rolling are controlled by a remote computerized device comprising a dedicated software application, and wherein the computerized device is selected from the group consisting of a laptop computer; a tablet; a desktop computer; a smartphone; and any combination thereof.

18. The method of claim 16, wherein said at least two portable structures are mechanically connected to one another.
